(19) United States
(12) Patent Application Publication
(10) Pub. No.: US 2002/0066355 A1
(43) Pub. Date: Jun. 6, 2002

(54) Flexible mouthpiece for a brass musical instrument

(76) Inventor: Gerald R. Parkos, Sacramento, CA (US)

Correspondence Address: Bradley P. Heisler, Heisler & Associates, Suite 300, 3017 Douglas Blvd., Roseville, CA, 95661, US

(21) Appl. No.: 09/729,732

(22) Filed: Dec. 4, 2000

(51) Int. Cl. G10D 9/02

(52) U.S. Cl. 84/398

(57) ABSTRACT

A mouthpiece 10 is provided for a musical instrument such as a trumpet, cornet, trombone, or other horn. The mouthpiece 10 includes a cup 20 surrounded by a rim 21. The rim 21 is formed of a resilient flexible material. A coil 30 formed of an inelastic elongate filament defines one form of a means to restrict radial expansion of the rim 21. Hence, the rim 21 can be compressed axially but resists radial expansion. The flexible resilient rim 21 assists a player in forming and maintaining proper embouchure when utilizing the mouthpiece 10. The specific hardness of the rim 21 can be selected to match a player's preference and would tend to have a Shore A rating of less than 90, with Shore A rating in the range from 10-60 being considered optimal.

### FIELD OF THE INVENTION

The following invention relates to mouthpieces for musical instruments made from a variety of materials but commonly referred to as “brass” instruments, such as trumpets and other musical instruments in the horn family. More particularly, this invention relates to mouthpieces for musical instruments which include a cup formed from a non-rigid material.

### BACKGROUND OF THE INVENTION

Brass instruments such as trumpets, coronets, trombones, and other musical instruments in the horn family all typically include variations on a mouthpiece of a standard basic configuration. This standard configuration includes a cup surrounded by a rim with the cup leading to a throat which then passes through a back bore or shank. The mouthpiece typically attaches to a lead pipe or other portion of the musical instrument into which air flows. The player of the musical instrument places lips adjacent the rim of the mouthpiece and partially into the cup during playing of the musical instrument.

One of the most difficult hurdles in learning to properly play a brass musical instrument is developing proper embouchure, or lip position, adjacent the cup of the mouthpiece. One reason for the difficulty in developing proper embouchure is that the rim and cup of all known prior art brass musical instrument mouthpieces are entirely rigid. This rigidity of the cup and rim of the mouthpiece increases a required lip strength which the player must have if proper embouchure is to be attained and maintained during playing of the musical instrument. While most mouthpieces for brass musical instruments are themselves formed from brass, and often plated with a precious metal such as silver or gold, other materials are known in the prior art. For instance, the patent to Wean (U.S. Pat. No. 4,658,697) teaches a training mouthpiece for brass instruments which includes a cup and rim formed of transparent material such as an acrylic plastic. Wean utilizes this acrylic plastic material so that lip position can be observed by a teacher to help a student in developing proper embouchure. Nothing in Wean suggests that the plastic or other material forming the mouthpiece be anything less than entirely rigid.

The patent to Schuster (U.S. Pat. No. 546,939) teaches providing a mouthpiece for metal musical instruments which includes a layer of rubber over underlying metal structure. Schuster teaches providing this rubber layer for its low heat conducting characteristics. The thin rubber or other non-heat conducting material merely provides the cover and no flexibility or resiliency is provided to the underlying rim of the mouthpiece itself.

The patent to Gulick (U.S. Pat. No. 1,740,013) teaches a mouthpiece for musical instruments which has a lip portion which is either made of a transparent phenolic condensation product (Bakelite) or a hard rubber. The motivation for utilizing this material is not disclosed in the patent to Gulick. However, the rigidity of the Gulick mouthpiece is made clear in that the patent to Gulick describes providing a holder for the mouthpiece which includes an extension to surround an exterior of the mouthpiece to reinforce the mouthpiece against breakage. These materials hence apparently exhibit brittleness, rather than any form of flexibility or elasticity.

Any mouthpiece cup formed of a resilient material would benefit from axial flexibility and elasticity, but would undesirably expand radially, altering a width of the cup and effecting proper lip position. Accordingly, a need exists for a mouthpiece which has a cup and rim formed of flexible elastic materials but which resists radial expansion.

### SUMMARY OF THE INVENTION

This invention provides a mouthpiece which has a basic geometric configuration similar to that provided by known prior art mouthpieces. However, a rim portion of the mouthpiece surrounding the cup is not formed from metal or other rigid materials. Rather, the rim surrounding the cup is formed of an elastic material, such as urethane. This elastic material allows the rim of the cup to be compressed axially.

Preferably, the rim of this invention is reinforced in a manner allowing axial compression but resisting radial expansion which would otherwise occur due to forces applied to the rim by lips of a player and air pressure exerted by the player. While this reinforcement can take many forms, preferably a coil of elongate flexible inelastic material is embedded within the rim. This filament extends circumferentially so that it does not impede axial compression of the rim. However, this filament resists radial expansion of the rim away from a central axis of the cup.

### OBJECTS OF THE INVENTION

Accordingly, a primary object of the present invention is to provide a mouthpiece for a brass musical instrument which has a flexible rim surrounding the cup.

Another object of the present invention is to provide a mouthpiece for a musical instrument which features a resilient cup.

Another object of the present invention is to provide a mouthpiece for a musical instrument which more easily allows a player to attain and maintain proper embouchure.

Another object of the present invention is to provide a mouthpiece for a musical instrument which has a rim surrounding the cup of the mouthpiece which is compressible axially but resists expansion radially.

Other further objects of the present invention will become apparent from a careful reading of the included drawing figures, the claims and detailed description of the invention.

### BRIEF DESCRIPTION OF THE DRAWINGS

FIG. 1 is a full sectional view of the mouthpiece of this invention before axial compression of a resilient rim and cup portion of the mouthpiece.

FIG. 2 is a full section of a standard prior art mouthpiece.

FIG. 3 is a detail of a portion of that which is shown in FIG. 1 with a rim of a cup portion of the mouthpiece compressed axially, and illustrating resistance to expansion radially.

FIG. 4 is a perspective view of an elongate flexible inelastic filament providing one form of a radial reinforcement for the rim of the mouthpiece of this invention.

FIG. 5 is a side elevation view of the mouthpiece of this invention.

### DESCRIPTION OF THE PREFERRED EMBODIMENT

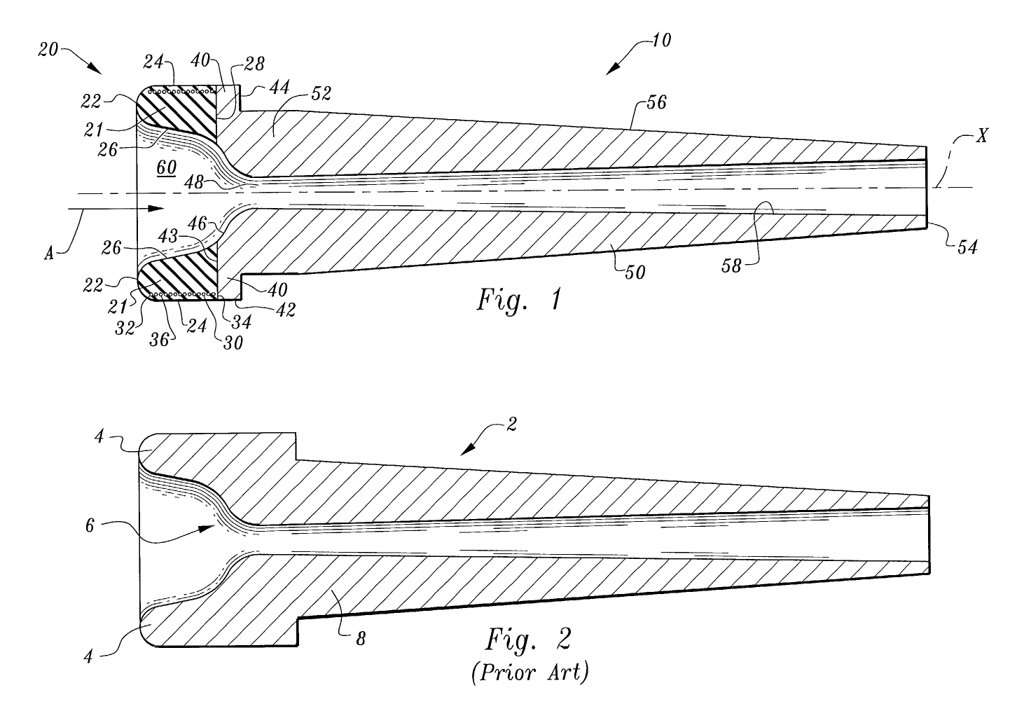

Referring to the drawings, wherein like reference numerals represent like parts throughout the various drawing figures, reference numeral 10 (FIG. 1) is directed to a flexible mouthpiece for a musical instrument such as that commonly referred to as a brass instrument or horn. The mouthpiece 10 uniquely includes a cup 20 with a rim 21 formed of a resilient material.

With particular reference to FIG. 2 basic structural details of a standard prior art mouthpiece 2 are described. The standard prior art mouthpiece 2 includes a radially symmetrical rim 4 surrounding a cup 6 into which lips of a player are placed when utilizing the mouthpiece 2. The cup 6 has an interior which passes through a throat and leads into a back bore 8 or shank. The back bore 8 is configured to be inserted into a lead pipe of the instrument so that air passing from the cup, through the throat and into the back bore passes on into the instrument. The prior art mouthpieces 2 are typically formed from a single homogeneous rigid metallic material. Typically, this material is brass and a plating of a precious metal such as silver or gold is applied to an exterior surface thereof. While other materials are known in the prior art for use in mouthpiece 2 formation, none of these materials are non-rigid.

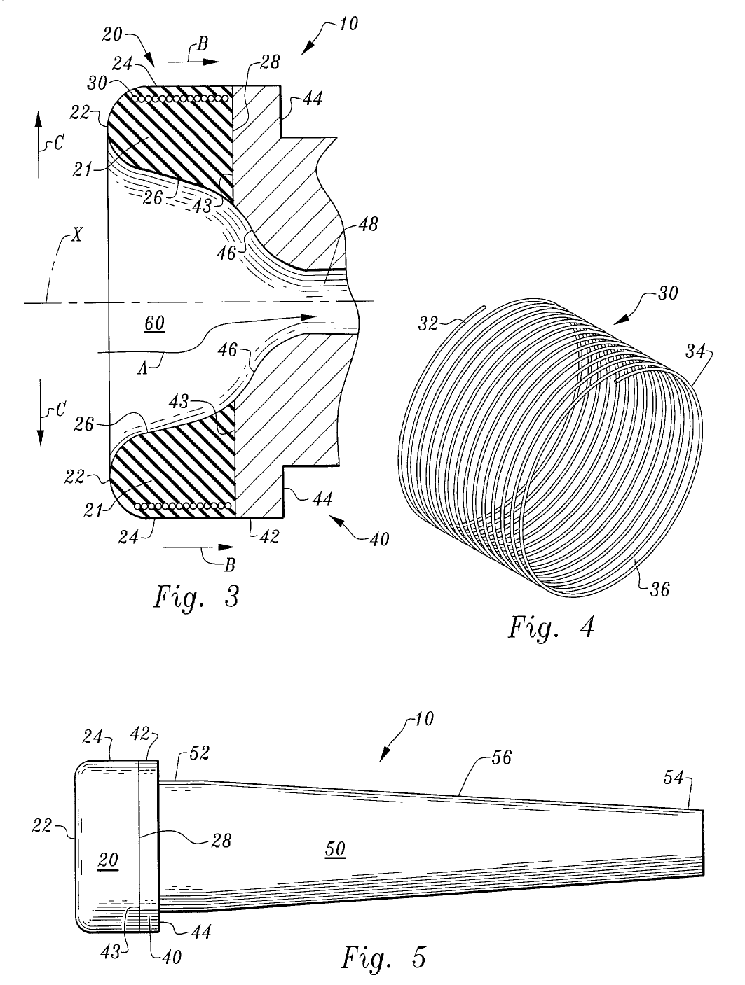

With particular reference to FIG. 1, the basic structural details of the mouthpiece 10 of this invention are described. The mouthpiece 10 of this invention has a geometric configuration similar to that found in the mouthpieces 2 of the prior art (FIG. 2). Hence, the mouthpiece 10 includes a cup 20 surrounded by a rim 21. A flange 40 steps an outer contour of the mouthpiece 10 from a larger diameter adjacent the cup 20 down to a lesser diameter adjacent a back bore 50. The mouthpiece 10 includes the rim 21 formed of a resilient material. A reinforcing coil 30 or other form of radial reinforcement is provided within the rim 21 to bias the rim 21 to be more flexible axially (along arrow B of FIG. 3) than flexible radially (along arrow C of FIG. 3).

More specifically, and with particular reference to FIG. 3, details of the cup 20 portion of the mouthpiece 10 are described. While the cup 20 has a geometric contour similar to that of the prior art mouthpiece cup 6, the cup 20 of this invention uniquely includes the rim 21 formed of an elastic material and other portions of the cup 20 formed of rigid material along with the back bore 50.

The rim 21 includes a tip 22 defining a forward-most annular portion of the cup 20. The rim 21 includes an outer cylindrical surface 24 and an inner surface 26 which tapers inwardly towards a central axis X of the mouthpiece 10. Preferably, all the structures of the cup 20 are radially symmetrical about the central axis X. The inner surface 26 does not taper at a constant rate. Rather, it curves inwardly in a manner providing a lip space 60 within the cup 20 which is somewhat bowl shaped. The rim 21 portion of the cup 20 ends at a base 28 opposite the tip 22. The base 28 provides a transition where the resilient material forming the rim 21 abuts a rigid flange 40 of the cup 20.

With particular reference to FIGS. 1, 3 and 4, details of a coil 30 for resisting radial expansion (along arrow C) of the rim 21 are described. The coil 30 provides one form of a means to restrict radial expansion of the rim 21 along arrow C (FIG. 3). The coil 30 preferably extends helically from a first end 32 to a second end 34. Gaps 36 are provided between adjacent turns of the filament forming the coil 30. The overall coil 30 has a cylindrical form which generally matches a cylindrical form for the outer cylindrical surface 24 of the rim 21, but with a slightly lesser diameter.

The filament forming the coil 30 can be flexible, such as dental floss or more rigid in form, such as spring steel. The filament forming the coil 30 is preferably substantially inelastic longitudinally. In this way, the filament restrains the rim 21 from increasing in circumference, and hence restrains the rim 21 from radial expansion (away from the central axis X along arrow C (FIG. 3)). However, the coil 30 preferably does not significantly impede axial compression of the rim 21 in a direction parallel to the central axis X and along arrow B (FIG. 3). To assure that axial compression of the rim 21 is not obstructed by the coil 30, the coil 30 preferably includes the gaps 36 between adjacent turns of the filament forming the coil 30. If desired, an amount of axial compression can be provided with a limit by properly sizing the gap between the turns in the filament forming the coil 30. When the adjacent turns in the filament forming the coil 30 abut each other, the coil 30 will have “bottomed out” and further axial compression will be resisted.

Other alternative radial reinforcement structures could also be used to provide the means to restrict radial expansion of the rim 21. For instance, the coil 30 can be replaced with a series of rings which are not connected together, but are spaced by gaps similar to the gaps between turns in the filament forming the coil 30 of the preferred embodiment. The rings could be formed from a flexible material such as dental floss or other thread, or could be formed from more rigid metals, plastics or other rigid materials.

Also, the coil 30 of the preferred embodiment could be substituted with a rigid cylindrical shroud outboard of and abutting the outer cylindrical surface 24 of the rim 21. Such a cylindrical shroud would prevent the rim 21 from moving outward radially beyond the original position of the outer cylindrical surface 24. Such a shroud could be supported by the flange 40 and other rigid portions of the mouthpiece 10.

It is also conceivable that the coil 30 of the preferred embodiment could be replaced by selecting a material for the rim 21 which inherently has asymmetric flexibility attributes. While no appropriate such material is currently known to the inventor, if such a material currently exists or is developed in the future which exhibits greater elasticity in an axial direction than is experienced in a radial direction, such a material could function to form the rim 21 of this invention and the radial reinforcement structure.

Another alternative means to restrict radial expansion of the rim 21 involves forming the rim 21 so that the flexible material only extends a short distance away from the tip 22. For instance, if the flexible material only extends approximately one-fourth of the distance away from the tip 22 as the amount shown in FIG. 1, essentially no radial expansion of the rim 21 will occur. The tip 22 is the most important portion of cup 20 to be formed from the flexible material. Hence, many of the benefits of this invention can still be provided and restriction of radial expansion of the rim 21 can be accomplished to some extent by limiting the flexible material to extending only part way from the tip 22, rather than as far as that shown in FIG. 1.

Of course, the extent of the flexible material could exceed a distance of one-fourth of the distance shown in FIG. 1 and be increasingly susceptible to undesirable radial expansion of the rim 21. Up to half of the rim 21 shown in FIG. 1 could conceivably be made from a flexible material with the remainder of the rim 21 being made from rigid material and provide a workable compromise between providing flexibility near the tip 22 of the rim 21 and maintaining sufficient rigidity in other portions of the rim 21 to allow some restriction of radial expansion of the rim 21.

Similarly, the amount of flexible material extending away from the tip 22 could be less than a fourth of the distance shown for the rim 21 in FIG. 1. As the amount of flexible material provided extending away from the tip 22 is decreased, the benefits provided by the flexible material on the rim 21 are decreased. Some benefit according to this invention is still provided so long as at least a first ten percent of the rim 21 shown in FIG. 1 is provided with the flexible material adjacent the tip 22.

Most preferably, the rim 21 is formed from urethane. However, other materials could be used provided that they have the desired elasticity and resiliency characteristics. Specifically, it is desirable that the rim 21 be capable of flexibility deforming somewhat when pressure is exerted by the lips of a player against the rim 21. The material forming the rim 21 should elastically return to its original form after these forces are released.

In general, a softer material for the rim 21 decreases an amount of lip strength necessary to maintain proper embouchure. On the other hand, a softer material for the rim 21 may be more difficult for an experienced player to adapt to. Hence, it is anticipated that softer materials would be utilized in forming the rim 21 when training a player for the first time. That player would then likely upgrade to somewhat harder materials forming the rim 21 as the player's experience and skill improves. Additionally, skilled players could choose a hardness for the material forming the rim 21 which would meet the player's particular preference. Some players might enjoy a harder material forming the rim 21 and others might enjoy a material for the rim 21 which is softer. Urethanes of various different harnesses can be utilized so that different materials are not necessary outside of the class of urethane materials and provide the hardness for the rim 21 at the level desired for the player. However, for some harnesses other materials outside of urethanes, such as various rubbers or soft plastics or other polymeric hydrocarbons could successfully be utilized depending on the preferences and desires of the player.

The hardness of the material forming the rim 21 can be quantitatively evaluated by reference to the “Shore A” hardness scale. “Shore” is a registered trademark of Instron Corporation of Canton, Massachusetts. Details about the Shore hardness scale and durometer hardness measurements can be provided by reference to the ASTM D2240 standard. On the Shore A hardness scale, a lower number indicates a softer material and a higher number indicates a harder material. A material with a 0 score is infinitely soft. A material with a score of 100 is infinitely hard. As a reference point, a score of 90 would be indicative of a material with a hardness similar to that of a hard rubber. A score of 10 or below would indicate a very soft material. While materials ranging from a Shore A hardness score of 0-90 could conceivably be used to form the rim 21 and exhibit some effectiveness, it is expected that materials having a Shore A score below 10 would be too soft for most uses and a Shore A score between 60 and 90 would be too hard for most uses. Hardnesses above 90 would essentially match hardness characteristics of metals, plastics, bakelite, hard rubber and other materials known in the prior art for mouthpiece rims.

Within the Shore A range of 10-90, various different players would be expected to utilize their own judgment in determining which hardness is most desirable. For instance, a professional musician who is already comfortable with very hard metallic mouthpiece rims might appreciate a rim 21 formed of a material having a hardness with a Shore A rating between 30 and 60 with a rating of 40 perhaps representing an average most desirable rating for a material enjoyed by most professional players. Beginner players might appreciate a softer material for the rim 21 with a Shore A rating between 10 and 30, at least initially. Such a beginner player might then progress to harder materials for the rim 21 as the player's experience increases.

The rim 21 can either be permanently attached to the flange 40 of the cup 20 or be removably attachable through the base 28. For instance, a light adhesive could be utilized to only temporarily attach the rim 21 to the flange 40 through the base 28. If the rim 21 is not permanently attached to the flange 40, various different rims 21 of different materials could be substituted without requiring the purchase of separate entire mouthpieces 10. Alternatively, the rim 21 can be permanently attached to the flange 40 through the base 28 so that a firm connection is provided.

If the rim 21 is to be removably attachable, a most preferred method for such removable attachability is to provide a cylindrical collar extending from the flange 40 outboard of the outer cylindrical surface 24 of the rim 21. This collar would include threads on an inside surface thereof. A replaceable rim 21 would be provided with threads on the outer cylindrical surface 24 which mate with the threads of this collar. In this way, the rim 21 can be rotatably inserted into the collar.

While the drawings (i.e. FIG. 1) show a transition between the rim 21 and the flange 40 being near the throat 48, this transition between the rim 21 and the flange 40 for removably attachable rims 21 would most commonly be closer to the tip 22 than as depicted in FIGS. 1 and 3. The diameter of the lip space 60 would be defined partly by the inner surface 26 of the removably attachable rim 21 and partly by the tapering surface 46 of the flange 40. The inner surface 26 of the rim 21 and the tapering surface 46 of the flange 40 would be carefully manufactured to exacting tolerances so that an exact smooth transition would occur between such a removable rim 21 and the flange 40. As an alternative to threads between the collar on the flange 40 and the removable rim 21 outer cylindrical surface, other removable attachment systems could be provided.

The flange 40 defines portions of the cup 20 beyond the rim 21 which rigidly couple the cup 20 to the back bore 50. The flange 40 includes an outside surface 42 which extends cylindrically beyond the outer cylindrical surface 24 of the rim 21. A planar face 43 defines a portion of the flange 40 which abuts against the base 28 of the rim 21. A step 44 is formed in the outside surface 42 of the flange 40. The step 44 provides an abutment at which a lead pipe or other portion of the musical instrument would rest when the mouthpiece 10 is inserted within the lead pipe.

A tapering surface 46 is provided on an interior of the flange 40 which completes the interior of the cup 20. The inner surface 26 of the rim 21 and the tapering surface 46 of the flange 40 together define a boundary of a lip space 60 within the cup 20. The tapering surface 46 transitions into a throat 48 that leads into the back bore 50.

The flange 40 is preferably formed of the same material as the back bore 50, preferably brass. Alternatively, the flange 40 can be formed of other materials. With appropriate reinforcement, the flange 40 could be formed of a common material with the rim 21 of the cup 20.

The back bore 50 extends from the flange 40. The back bore 50 includes a front end 52 adjacent the flange 40 and a rear end 54 opposite the front end 52. An outer conical wall 56 extends from the step 44 in the flange 40 to the rear end 54. An inner tapering wall 58 extends from the throat 48 to the rear end 54. While the back bore 50 is shown with specific tapering contours, various different configurations can be provided for the back bore including cylindrical interior and exterior walls or other differing surfaces and contours, depending on the particular performance desired for the mouthpiece 10.

The back bore 50 serves the basic function of directing air, passing along arrow A (FIGS. 1 and 3) from the lip space 60 of the cup 20 through the throat 48 and on through the back bore 50 and into the lead pipe of the musical instrument. Some musical instruments could include a cup 20 formed directly onto the lead pipe of the musical instrument. For such an instrument, the cup 20 would itself form the entire mouthpiece and no back bore or shank would be provided. The resilient rim 21 could function on such a cup 20 without a back bore just as the resilient rim 21 functions with the cup 20 of the preferred embodiment.

This disclosure is provided to reveal a preferred embodiment of the invention and a best mode for practicing the invention. Having thus described the invention in this way, it should be apparent that various different modifications can be made to the preferred embodiment without departing from the scope and spirit of this disclosure. When structures are identified as a means to perform a function, the identification is intended to include all structures which can perform the function specified.

What is claimed is:

1. A flexible mouthpiece for a brass musical instrument, comprising in combination:
a cup including a rim surrounding a lip space;
a back bore coupled to said cup and extending away from said cup;
a throat between said cup and said back bore; and
said rim of said cup at least partially formed from a flexible material.

2. The mouthpiece of claim 1 wherein said rim is formed from a material having a Shore A rating up to about 90.

3. The mouthpiece of claim 2 wherein said rim is formed from a material having a Shore A rating of between about 10 and about 60.

4. The mouthpiece of claim 1 wherein said rim is formed from a material which is softer than hard rubber.

5. The mouthpiece of claim 1 wherein said rim includes a radial reinforcement structure causing said rim to be more flexible axially than radially.

6. The mouthpiece of claim 1 wherein said rim is substantially non-flexible radially and flexible axially.

7. The mouthpiece of claim 1 wherein said rim includes a filament extending circumferentially within said rim, said filament being substantially inelastic circumferentially, such that said filament causes said rim to resist radial expansion.

8. The mouthpiece of claim 5 wherein said rim includes a substantially rigid shroud abutting an outer surface of the rim opposite an inner surface of the rim facing said lip space, said shroud formed as a substantially rigid material to resist radial expansion of said rim.

9. The mouthpiece of claim 1 wherein said material forming said rim is both flexible and elastic, such that said rim resiliently returns to an original form after forces are removed from said rim.

10. The mouthpiece of claim 1 wherein said material forming said rim is taken from a urethane class of materials.

11. An elastic mouthpiece for a musical instrument, comprising in combination:
a cup including a rim surrounding a lip space;
a shank coupled to said cup and extending away from said cup, said shank having an interior bore open to said lip space; and
said rim at least partially formed from an elastic material.

12. The mouthpiece of claim 11 wherein said rim includes a means to restrain radial expansion of said rim while allowing axial compression of said rim.

13. The mouthpiece of claim 12 wherein said radial expansion restraining means includes at least one circumscribing elongate filament, said filament less elastic than said elastic material forming said rim.

14. The mouthpiece of claim 13 wherein said filament extends multiple times around said cup with said filament embedded within said elastic material forming said rim, said filament being substantially inelastic.

15. The mouthpiece of claim 13 wherein said at least one filament includes two or more rings embedded within said elastic material forming said rim.

16. The mouthpiece of claim 12 wherein said radial expansion restraining means includes a substantially rigid cylindrical shroud located adjacent an outer cylindrical surface of said rim.

17. A mouthpiece of a musical instrument, comprising in combination:
a cup including a rim surrounding a lip space; and
said rim at least partially formed of a resilient material.

18. The mouthpiece of claim 17 wherein said resilient material forming said rim is more flexible axially than radially.

19. The mouthpiece of claim 18 wherein said resilient material forming said rim has a Shore A rating less than 90.

20. The mouthpiece of claim 19 wherein said rim includes a substantially inelastic elongate filament extending circumferentially within said rim, said filament causing said rim to exhibit greater flexibility axially than radially.
